(19) United States
(12) Patent Application Publication
(10) Pub. No.: US 2006/0267337 A1
(43) Pub. Date: Nov. 30, 2006

(54) Slip joint double Y apparatus and method

(76) Inventor: Michael Graybeal, Bloomington, IL (US)

Correspondence Address: HUSCH & EPPENBERGER, LLC, 190 CARONDELET PLAZA, SUITE 600, ST. LOUIS, MO, 63105-3441, US

(21) Appl. No.: 11/297,907

(22) Filed: Dec. 9, 2005

Related U.S. Application Data
(63) Continuation-in-part of application No. 11/127,413, filed on May 12, 2005.

(51) Int. Cl. F16L 39/00

(52) U.S. Cl. 285/131.1

(57) ABSTRACT

The present invention includes an adaptive slip joint coupling for connecting a fixture exit pipe to a wall pipe and also includes a system of couplings of varying dimensions, both providing for adaptable connections.

### CROSS-REFERENCE TO RELATED APPLICATIONS

This application is a continuation-in-part of U.S. patent application Ser. No. 11/127,413 filed on May 12, 2005.

### BACKGROUND OF THE INVENTION

1. Field of the Invention

The present invention is adjustable fitting apparatus and system for plumbing, particularly for low pressure drain/waste/vent (“DWV”) plumbing.

2. Related Art

There is a constant need in the plumbing arts to match plumbing fittings, particularly between an external fixture in a room and the drain, waste or vent pipes hidden behind the walls of the room. At least for the visible portion, there is a constant need that the fittings be made as visually appealing as possible. There is a further need for economy in the number of parts used, as well as economy in time and work required to complete an acceptable result.

Efficient fitting in plumbing is always desirable, particularly in DWV plumbing, and most especially for the type of construction that has become typical, that is to say, frame and drywall construction. Efficient fitting of plumbing fixtures to wall plumbing has been complicated by the fact that on typical construction projects the plumber and carpenter are on premise working on the same room at different times. Matching fittings can also be complicated by the very small amount of space within the wall for plumbing pipes and fixtures; space that might otherwise be available for adjustment. A commonplace situation is as follows: a building, either commercial or residential, is framed by a carpenter. A plumber will install plumbing lines within the walls that have been framed. Thereafter another carpenter or drywaller will follow and put the finish drywall on the frame, leaving a small hole allowing access to the pipes installed there previously by the plumber. After this step, another plumber returns to attach fixtures such as toilets, sinks and the like to the pipe in the wall, through the hole left in it for that purpose by the carpenter. It frequently happens that the fixture dimensions and/or changes in the wall dimensions made by the carpenter do not allow a properly fit in connection between the exit pipes of the fixture and the wall pipe. For example, carpenters sometimes move the wall out from the position indicated for it when the first plumber installed the wall pipes. For another example, the fixture might have a different dimension than planned for originally. A result of these events is that an unplanned for extension of the wall pipe must be created by the second plumber in order to adequately connect the fixture pipe in the room to the wall pipe provided for it.

Such adjustments are disadvantageous for at least two reasons. First, the extension fittings commonly available, most particularly typical PVC pipe and fittings, must be on the room side of the wall and are frequently too large to be covered up by the escutcheon provided for it. Secondly, the second plumber must take extra time, frequently on the order of an hour, to install extension fittings. Moreover, simply in order to achieve the extension fitting to complete the installation, the second plumber sometime has to cut a large square hole in the wall for sufficient access to the wall pipes. Thereafter, the carpenter must return in order to patch the hole in the wall, requiring another one to three hours of work.

Presently in the art there is a series of adapters and slip joint couplings having a variety of male and female threaded and nonthreaded fitting arrangements. None of the presently available fittings are adjustable or variable in the desirable dimensions. None of the presently available fitting systems provide a direct, threaded, sealing joint that can be adapted to the type of unanticipated dimension changes described above. Hence, there is a need in the art for a system providing a variety of threaded slip joint coupling dimensions, and/or an adjustable fitting adaptable to a variety of dimensions.

There is also a need for a reduction of parts, complexity, expense and difficulty of installation in under sink plumbing. Many of the same difficulties apply, as are described above, especially with dual sink installations, which require two P traps emptying into a single exit drain pipe in the wall. A change in sink configuration during initial construction or later during remodeling is complicated by prior art use of glued and therefore immovable fixtures. Under sink plumbing is also currently executed with heavy schedule 40 PVC in a configuration requiring six components. This heavy gauge of PVC preferred for gluing fixtures and multiplicity of components required to connect glued fixtures to threaded P traps is disadvantageous due to its costs, time and complexity in installation and resistance to change.

Illustrated in FIG. 6 is a prior art double Y and the components for installing it. It is comprised of the double Y fixture itself 510, which must be installed with trap adaptors 512A and 512B which are glued to orifices 514A and 514B. Thereafter slip joint rings 516 must be used. There is a plug adaptor 515 required which is glued to orifice 518. Thereafter a plug 520 is threaded into the plug adaptor. The plug is used for access to the plumbing for cleaning when necessary. At the exit end 522, a glued joint is required with a stock piece of PVC pipe (not shown) which in turn is glued to whatever PVC fitting has been left at the wall for connection.

As is readily apparent, the two trap adaptors, the plug adaptor and the extra portion of PVC pipe could all be advantageously removed and reduce costs, complexity and installation time. Also, in the absence of glue joints and their replacement with slip joints eases, speeds and cheapens the procedure for changing the installation. Accordingly, there is a need in the art for a less complex, less expensive, less time consuming and inflexible double Y sink installation apparatus.

### SUMMARY OF THE INVENTION

The present invention includes an adaptive slip joint coupling for connecting a fixture exit pipe to a wall pipe and also includes a system of slip joint couplings, T fixtures and a quarter bend fixtures of varying dimensions, both providing for adaptable connections.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

The present invention also includes slip joint and adaptable link features for a double Y under sink fixture which is adaptable to install with double P traps for a double sink.

### BRIEF DESCRIPTION OF THE DRAWINGS

The present invention will become more fully understood from the detailed description and the accompanying drawings, wherein:

FIG. 1 is a T fitting having a male threaded throat;

FIG. 2 is a cross section view of a female threaded slip joint adjustable coupling;

FIG. 3 is a double T fitting;

FIG. 4 is a double 90 fitting; and

FIG. 5 is cross sectional view of a system of variously dimensioned female threaded slip joint couplings.

FIG. 6 is a prior art double Y for a sink installation.

FIG. 7 is a perspective view of the adjustable slip joint double Y of the present invention.

FIG. 8 is a cutaway side view of the present invention.

FIG. 9 is a bottom view of the present invention.

### DETAILED DESCRIPTION OF THE PREFERRED EMBODIMENTS

The following description of the preferred embodiment(s) is merely exemplary in nature and is in no way intended to limit the invention, its application, or uses.

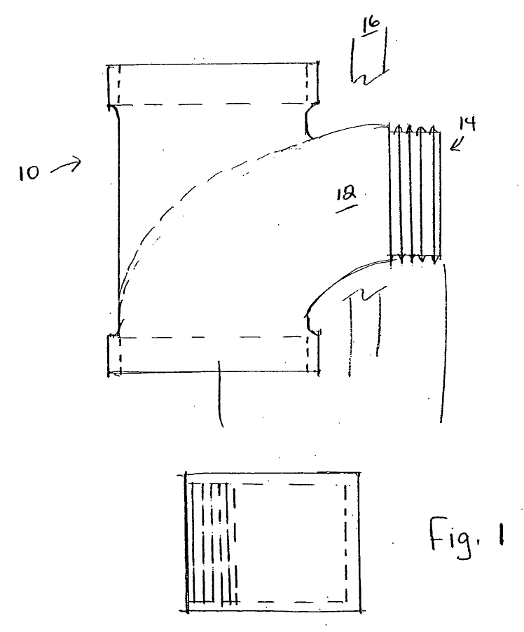

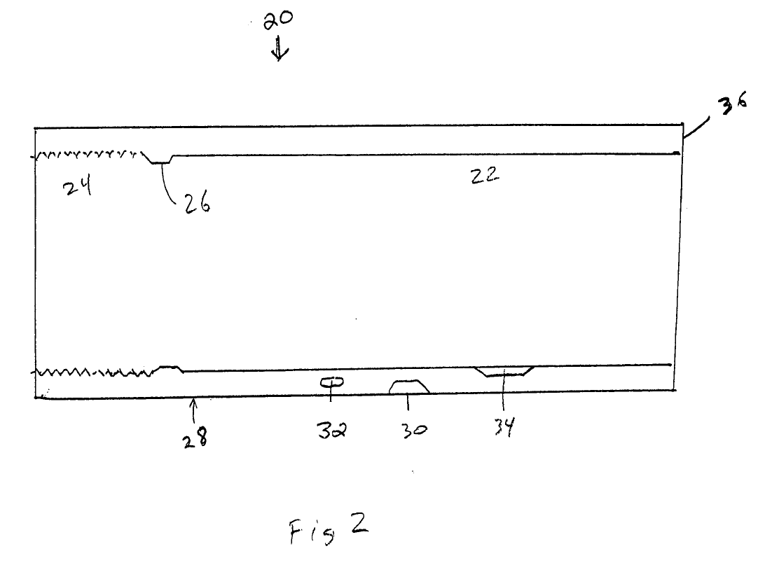

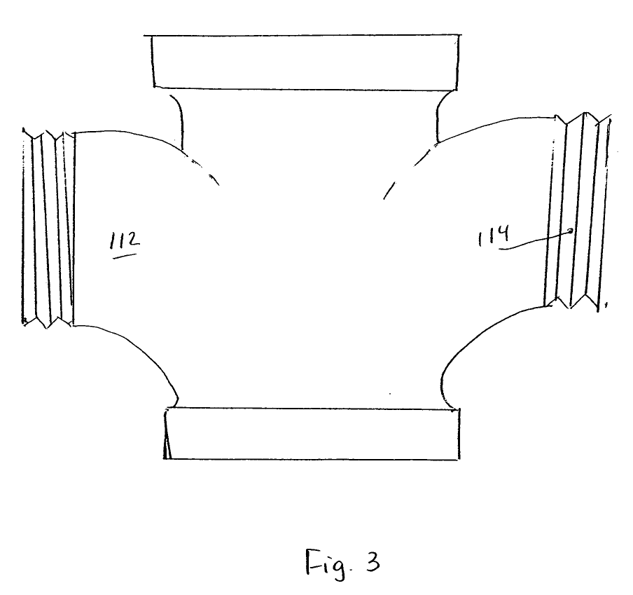

FIG. 1 depicts a T-fitting 10 having a throat 12 having an aperture with male threads 14 on the outside. A wall 16 is presented in cross section to indicate the anticipated installed position of the T-fitting 10. FIG. 2 is a cutaway version of an adjustable slip joint coupling having a female thread on its internal diameter. Female coupling 20 is comprised of an unthreaded extension 22 providing length that can be varied for adjustment. The threaded internal diameter 24 comprises a female portion dimensioned to threadingly engage male portion 14 of the T-fixture or other fixtures. A seal abutment 26 separating the threaded portion 24 and non-threaded portion 22 is provided for seating of a seal (not shown) in order to apply a water tight seal between an end of the fixture exit pipe, such as a P-trap pipe, and the male portion of the T or other fixture. The outer diameter of the adjustable slip joint coupling 20 may include a marker 28 just behind the location of the lip 26 on the internal diameter. This marker will indicate to a plumber that portion of the non-threaded length 22 of the coupling that is the extension which may be cut for adjustment.

In operation, the female slip joint coupling 20 will be measured by the plumber and cut with any of a variety of standard pipe cutters at any selectable place in the unthreaded portion 22 of the coupling. The plumber may cut through a standard thickness of the coupling wall, as indicated on the top portion of FIG. 2. Alternatively, the female coupling 20 may be fabricated such that preconfigured thin or weak portions of the coupling wall be included, such as notches or grooves on outside diameter 30, on an inside diameter 34, or hollow portions within the thickness of the coupling wall 32. For hollow portions 32 and internal diameter thin portions 34, one may alternatively include markers on the outside diameter indicating where these positions are. Alternatively, pieces could be screwed or glued together, using joining interfaces such as those shown in FIG. 5.

Having measured and cut the adjustable female slip joint coupling 20 to an appropriate length, the fixture exit pipe or P-trap pipe is inserted through female slip joint coupling 20, through a standard seal and then into throat 12 of T-fitting 10. The plumber then slides the female slip joint coupling 20 along the P-trap pipe until it engages male threads 14 on throat 12, whereupon the plumber screws the coupling in. Having adjusted the female coupling 22 an appropriate length, any escutcheon or other fixture provided will appropriately fit over end portion 36 of female coupling 20, thereby providing an esthetically acceptable finish.

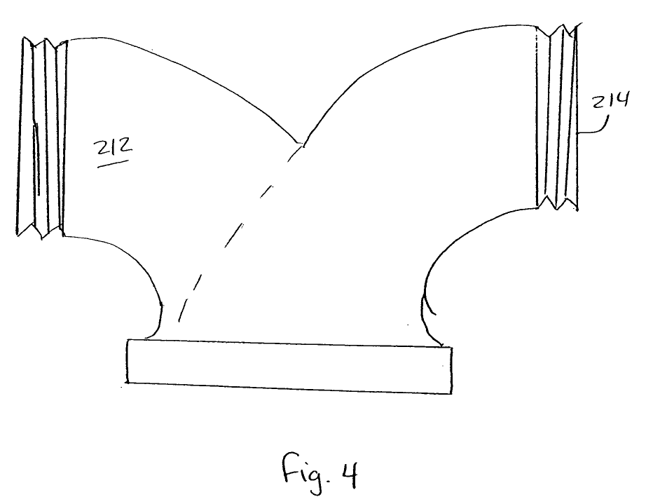

FIG. 4 shows a double throated T-fitting, each throat 112 having male threads 114. FIG. 5 shows a double threaded 90 fitting, which may also have the male threads of the present invention, 214. A single 90 having a male thread 214 is indicated on the right hand side of FIG. 4 in a profile corresponding to the phantom line in that figure.

The adjustable slip joint female threaded coupling of the present invention may mate with any of the depicted single throat T-fixture, double throat T-fixture, single throat 90 or double throat 90. Either or both of the fittings herein described may be made of any material, including cast iron, steel, plastic, and particularly polyvinylchloride (PVC).

FIG. 5 shows an alternate system wherein the adjustable female slip joint couplings 320 are each at a different length. The female threaded portions 324 and lips 326 are the same as depicted in FIG. 2. However, the unthreaded portion 322 is a different length for each of the depicted examples. Accordingly, in operation, the system of the present invention would include a plumber having various lengths of female threaded slip joint couplings in his tool box. When presented with a mismatched dimension for joining a fixture exit pipe with the wall pipe fitting when the wall pipe fitting is behind the wall, the plumber may choose the length of female threaded coupling 320 best suited for the dimensions at hand and proceed to fit the fixture with that selected coupling.

This invention eliminates one and sometimes two pieces normally needed for installation of plumbing fixture to wall pipe. It eliminates the need to carry a saw, PVC cleaner and PVC glue when setting fixtures and saves labor and material.

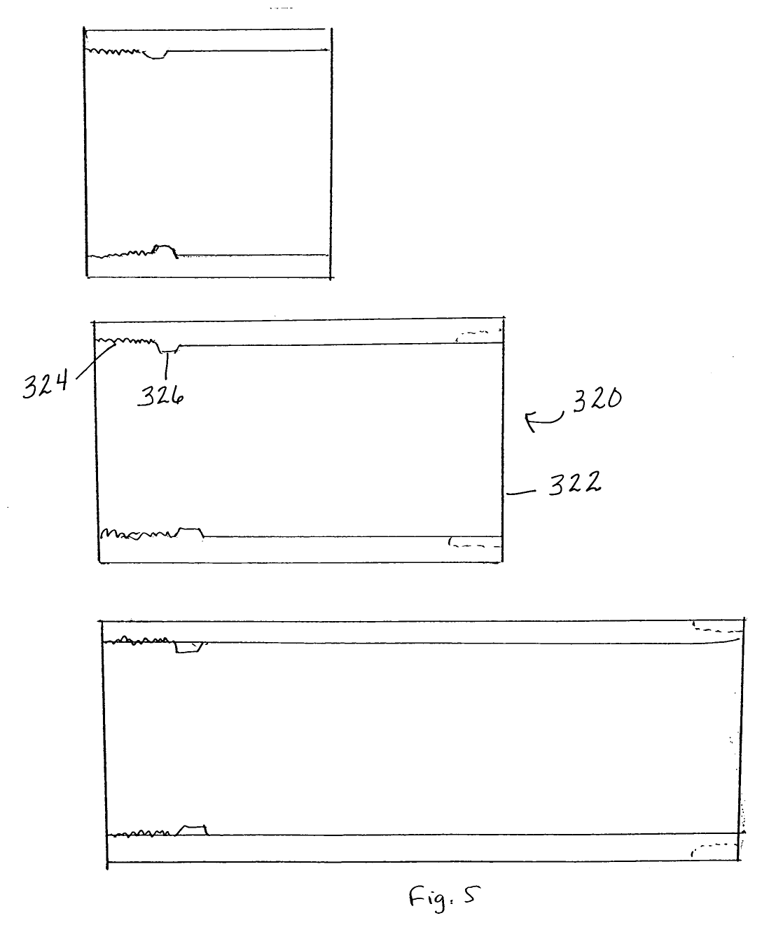

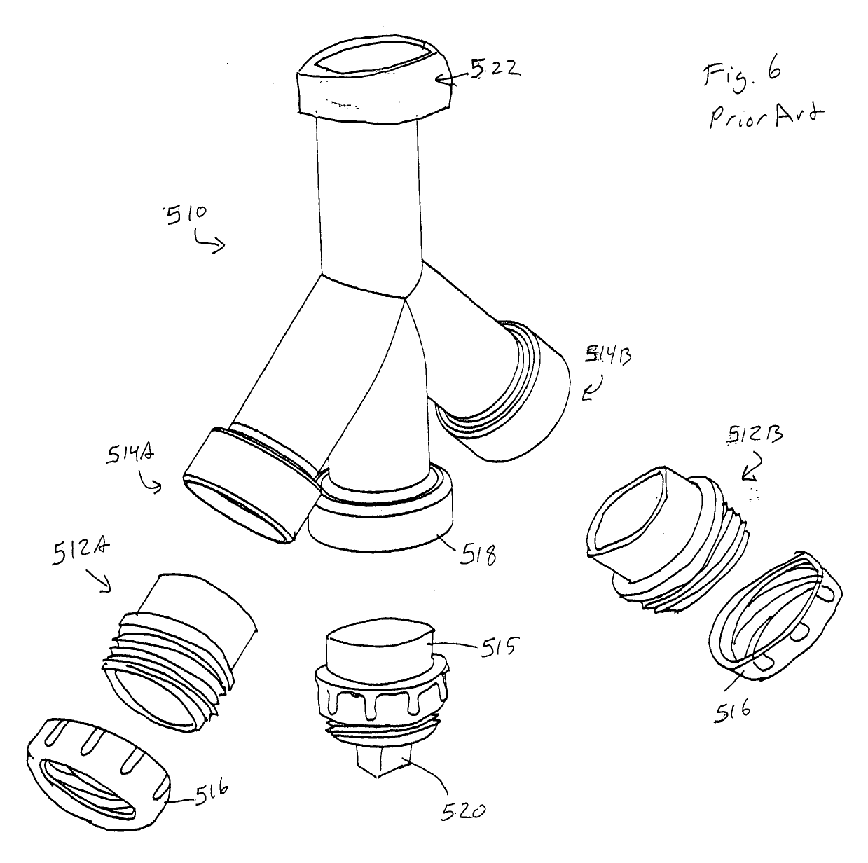

FIG. 6 depicts the prior art.

FIG. 7 is a perspective view of the double Y fixture of the present invention. Double Y fixture 410 is comprised of a main pipe 412 having an output aperture 414 at a first end and a plug aperture 416 at an opposite end. The double Y 410 also has two side pipes 418A and 418B each having an input aperture 420A and 420B. The input apertures are connected through a P trap to the sink drains (not shown). The input aperture end 420 of side pipes 418, has an angled or beveled interior surface 422A and 422B. These surfaces are dimensioned to receive and maintain a sealing abutment with a slip joint ring.

Each of the plug and input apertures are threaded. In the depicted embodiment, the side pipes 418 have male threads 424A and 424B. In the depicted embodiment, plug aperture 416 includes a female thread 426. Threading each of the side pipe and plug ends of the main pipe, eliminates the need for adapting fittings as was required by the prior art.

Main pipe 412 may be adjusted in length. The three embodiments are depicted in FIG. 7. A simple straight main pipe 412 and exit aperture 414 are shown. An adjustment could be made with conventional means such as cutting with a tube cutter or sawing to length. The main pipe 412 could then be glued with a conventional coupling.

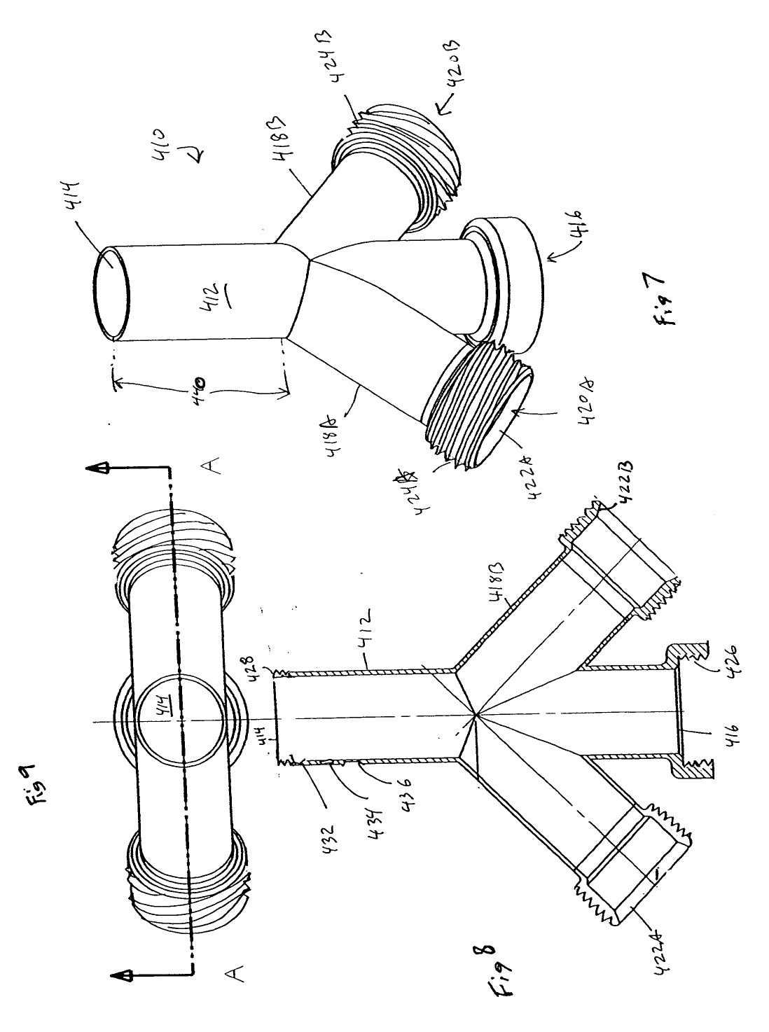

FIG. 8, the cutaway side view, shows a further embodiment. It is anticipated that main pipe 412 may be threaded 428 at end 414 or not. The invention may comprise a series of Y shaped couplings each having a different dimension 440 in order to accommodate different distances between a wall fixture and the sink outlets. In assembly then, the plumber would simply select the appropriate length, screw fit the main pipe 412 to the wall fixture with a slip joint, then screw fit the p-traps with slip joints at ends 420.

In the embodiment depicted in FIG. 8, the main pipe 412 may also be adjustable in dimension 440 in that weak portions are prefabricated into the wall of main pipe 412 in order to accommodate cutting to length. The weak portions may be an internal indentation in the wall 432, an internal hole in the wall 434, or an external indentation 436. In assembly, the plumber would cut the main pipe 412 along one of the weak points in order to adjust dimension 440 for installation accommodating various distances from the wall fixture to the sink outlet. The outside of the main pipe 412 may have markers corresponding to the weak points to indicate to the plumber where to cut.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A double Y plumbing fitting comprising:
a double Y fitting having an exit aperture, a plug aperture, a first intake aperture and a second intake aperture;
said first and second intake apertures each having threads configured to receive a slip joint;
said plug aperture having threads adapted to receive a plug; and
said exit aperture having weak points integrally fabricated therein and adapted for adjusting a distance between said exit aperture and said plug aperture.

2. The fixture of claim 1 further comprising a coupling, said coupling have an interior female thread;
a seal abutment, said seal abutment being on an interior wall of said coupling and said seal abutment being disposed to create a fluid seal with a seal ring upon installation of said coupling and said seal abutment being proximate to said interior female thread.

3. The fitting of claim 1 wherein said fitting is made of polyvinyl chloride.

4. The fitting of claim 1 wherein said threads of said intake orifices are male.

5. The fitting of claim 1 wherein said threads of said plug aperture are female.

6. The fitting of claim 1 wherein said plug aperture is threadless and adapted for glue fittings.

7. The fitting of claim 1 wherein said exit aperture is adapted to receive a slip joint.

8. A system for installing a double Y plumbing coupling, said system comprising:
providing a series of double Y fittings, each of said fittings having an exit aperture, a plug aperture, a first intake aperture and a second intake aperture;
said first intake aperture and said second intake aperture each having threads configured to receive a slip joint;
each of said fittings having a plug aperture having threads adapted to receive a plug;
each of said fittings having a seal abutment substantially at said exit aperture, said seal abutment being disposed to create a fluid seal with a seal ring upon installation of said fitting with a slip joint coupling;
wherein each of said series of fittings has a different length, said length being measured between said plug aperture and said exit aperture.

9. The fixture of claim 8 wherein said exit aperture is adapted to receive a slip joint.

10. A method of installing a double Y plumbing coupling comprising:
providing a double Y coupling having an exit aperture, a plug aperture, a first intake aperture and a second intake aperture;
plugging said plug aperture;
joining said first intake aperture to a provided P-trap with a slip joint coupling;
joining said second intake aperture with a provided P-trap with a slip joint coupling; and
connecting said exit aperture to a provided wall fitting with a slip joint coupling.

11. The method of claim 10 further comprising:
adjusting a length of said double Y coupling, said length being measured between said plug aperture and said exit aperture, before attaching said slip joint couplings.

12. The method of claim 11 wherein said adjustment of said length is by cutting said double Y fitting along a main pipe substantially adjacent to said exit aperture.

13. The method of claim 11 wherein said length adjustment step is executed by cutting or sawing said main pipe.

14. The method of claim 13 wherein said cutting or sawing is at an integrally fabricated weak point in said main pipe.

15. The method of claim 11 wherein said step of adjusting said length is by selecting one of a series of double Y fittings each of said double Y fitting in said series having a different length.
